(19) United States
(12) Patent Application Publication
(10) Pub. No.: US 2026/0271916 A1
(43) Pub. Date: Sep. 17, 2026

(54) METHODS FOR PREPARING, STORING, AND TRANSPORTING A NATIVE OR ENGINEERED ORGAN FOR TRANSPLANT

(71) Applicant: United Therapeutics Corporation, Silver Spring, MD (US)

(72) Inventors: Christopher Givens, Chapel Hill, NC (US); Ryan Bonvillain, Cary, NC (US); Thomas Petersen, Durham, NC (US); Sarah Seiler Hogan, Raleigh, NC (US); Bria Jones, Durham, NC (US)

(73) Assignee: United Therapeutics Corporation, Silver Spring, MD (US)

(21) Appl. No.: 19/562,277

(22) Filed: Mar. 10, 2026

Related U.S. Application Data
(60) Provisional application No. 63/769,932, filed on Mar. 11, 2025.

(51) Int. Cl. A01N 1/162; A01N 1/122; A01N 1/126; A01N 1/146; A01N 1/165

(52) U.S. Cl. CPC A01N 1/162; A01N 1/122; A01N 1/126; A01N 1/146; A01N 1/165

(57) ABSTRACT

A method of preparing, storing, and transporting a native or engineered organ for transplant, including a 10° C. solution comprising dextran and buffered at physiological pH. The solution may further include an additive selected from the group of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; methylcellulose or other space-filling or bulk-adding substance; or combinations thereof.

### CROSS-REFERENCE TO RELATED APPLICATIONS

This application claims priority under 35 U.S.C. § 119(e) to U.S. Provisional Application No. 63/769,932, filed Mar. 11, 2025, the content of which is hereby incorporated by reference in its entirety.

### FIELD

The present disclosure relates generally to methods for preparing, storing, and transporting a native or engineered organ for transplant, and in particular to native or engineered organ preservation solutions and methods for preparing an engineered organ for storage or transport.

### SUMMARY

An embodiment is a method for preparing a native or engineered lung for transport, comprising: (i) performing bronchoscopy and suction on the engineered lung, wherein the engineered lung remains in a recellularization bioreactor; (ii) adding a surfactant by the bronchoscope or other device to deliver the surfactant to an airway of the engineered lung; (iii) ventilating the engineered lung with a fraction of inspired oxygen (FiO₂) of 0.21 to 1.0 followed by a manual inspiratory hold and airway clamp to maintain the inspired oxygen in the engineered lung, wherein ventilating the engineered lung is performed with an electronic or manual mechanical ventilation device; (iv) clamping the airway when the engineered lung is inflated; (v) removing the engineered lung from the recellularization bioreactor; and (vi) bathing the engineered lung in a 4° C. solution comprising dextran and buffered at physiological pH. Optionally, negative pressure support for ventilatory recruitment may be applied both before and during lung transport for transplant.

Another embodiment is a method for preparing a native or engineered lung for transport, comprising: (i) removing the engineered lung from a recellularization bioreactor; (ii) externally cooling the engineered lung in a 4° C. solution comprising dextran and buffered at physiological pH; (iii) flushing vasculature of the engineered lung with a 4° C. solution comprising dextran and buffered at physiological pH; (iv) performing bronchoscopy and suction on the engineered lung; (v) adding a surfactant into the engineered lung by the bronchoscope or other device to deliver the surfactant to an airway of the engineered lung; and (vi) ventilating the engineered lung with a FiO₂ of 0.21 to 1.0 followed by a manual inspiratory hold and airway clamp at peak inflation to trap gas in the engineered lung, wherein ventilating the engineered lung is performed with an electronic or manual mechanical ventilation device. Optionally, negative pressure support for ventilatory recruitment may be applied both before and during lung transport for transplant.

Another embodiment is a method of transporting a native or engineered organ for transplant, comprising providing a first container containing a 10° C. solution comprising dextran and buffered at physiological pH and configured to receive and hold the native or engineered organ therein; providing a second container configured to receive and hold the first container therein; placing the native or engineered organ into the first container; placing the first container into the second container; and transporting the native or engineered organ, wherein the second container preserves the temperature of the native or engineered organ at a temperature of about 10° C. for at least 2 hours.

Another embodiment is any of the preceding methods wherein negative pressure support is provided, wherein a negative pressure of −1 to −40 cmH2O is applied to a lung, preferably an engineered lung, contained within a fixed volume chamber using an electronic or manual device while the tracheobronchial opening of the lung is vented to atmospheric pressure such that the negative pressure on the outside of the lung causes air to flow into the tracheobronchial tree and distally to inflate the alveoli.

Another embodiment is a method for preparing a native or engineered lung for transport, comprising: (i) performing bronchoscopy and suction on the engineered lung, wherein the engineered lung remains in a recellularization bioreactor; (ii) adding a surfactant by the bronchoscope or other device to deliver the surfactant to an airway of the engineered lung; (iii) inflating (recruiting) and ventilating the engineered lung using positive or negative pressure, with a fraction of inspired oxygen (FiO₂) of 0.21 to 1.0 followed by a manual inspiratory hold and airway clamp to maintain the inspired oxygen in the engineered lung, wherein inflating the engineered lung is performed using positive or negative pressure with an electronic or manual mechanical ventilation device; (iv) clamping the airway when the engineered lung is inflated; (v) removing the engineered lung from the recellularization bioreactor; and (vi) bathing the engineered lung in a 4° C. solution comprising dextran and buffered at physiological pH.

Another embodiment is a method for preparing a native or engineered lung for transport, comprising: (i) removing the engineered lung from a recellularization bioreactor; (ii) externally cooling the engineered lung in a 4° C. solution comprising dextran and buffered at physiological pH; (iii) flushing vasculature of the engineered lung with a 4° C. solution comprising dextran and buffered at physiological pH; (iv) performing bronchoscopy and suction on the engineered lung; (v) adding a surfactant into the engineered lung by the bronchoscope or other device to deliver the surfactant to an airway of the engineered lung; and (vi) (recruiting) and ventilating the engineered lung using positive or negative pressure, with a FiO₂ of 0.21 to 1.0 followed by a manual inspiratory hold and airway clamp at peak inflation to trap gas in the engineered lung, wherein inflating the engineered lung is performed using positive or negative pressure with an electronic or manual mechanical ventilation device.

Another embodiment is a solution comprising a buffer to maintain physiological pH, dextran, and an additive, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof. The solution may be used in a method for preparing an organ for transport or during transport.

Another embodiment is a solution comprising a buffer to maintain physiological pH, dextran, and methylcellulose or other space-filling or bulk-adding substance.

### BRIEF DESCRIPTION OF THE FIGURES

FIG. 1 illustrates removing an engineered organ from a recellularization bioreactor, storing the engineered organ at about 10° C., transporting the engineered organ to the transplant site, rewarming the engineered organ to body temperature, and transplanting the engineered organ, according to some embodiments.

FIGS. 2A-2B show the effects of an additive containing an omega-9 monounsaturated fatty acid and omega-6 polyunsaturated fatty acid admixture (e.g., Clinolipid) on surfactant protein B secretion (SP-B) in a lung model (FIG. 2A), and nutrient metabolism in Human Pulmonary Artery Endothelial Cells (HPAEC; FIG. 2B), according to some embodiments.

FIG. 3 shows the effects of an additive containing glycogen on nutrient metabolism in HPAEC, according to some embodiments.

FIG. 4 shows the effects of an additive containing a vitamin B1, vitamin B2, vitamin B6, vitamin B12, niacinamide, dexpanthenol, folic acid, and biotin admixture (e.g., Infuvite) on nutrient metabolism in HPEAC, according to some embodiments.

FIG. 5 shows the effects of a methylcellulose additive on pulmonary vascular resistance in a late engineered lung culture, according to some embodiments.

FIG. 6A shows increase in measured tidal volume post treatment with negative pressure for recruitment of a representative native lung model, and FIG. 6B shows increase in measured dynamic compliance post treatment with negative pressure recruitment in a representative native lung model. Ventilation support remained constant for all measurements.

### DETAILED DESCRIPTION

Unless otherwise specified “a” or “an” means one or more.

As used herein, the term “about” placed before a specific numeric value may mean ±20% of the numeric value; ±18% of the numeric value, ±15% of the numeric value; ±12% of the numeric value; ±8% of the numeric value; ±5% of the numeric value; ±3% of the numeric value; ±2% of the numeric value; ±1% of the numeric value or ±0.5% of the numeric value.

The present disclosure provides methods for preparing an engineered lung for transport. In one embodiment, preparing the engineered lung for transport is accomplished by (i) performing bronchoscopy and suction on the engineered lung, wherein the engineered lung remains in a recellularization bioreactor; (ii) adding a surfactant by the bronchoscope or other device to deliver the surfactant to an airway of the engineered lung; (iii) ventilating the engineered lung with a fraction of inspired oxygen (FiO₂) of 0.21 to 1.0 followed by a manual inspiratory hold and airway clamp to maintain the inspired oxygen in the engineered lung, wherein ventilating the engineered lung is performed with an electronic or manual (e.g., Ambu bag) mechanical ventilation device; (iv) clamping the airway when the engineered lung is inflated; (v) removing the engineered lung from the recellularization bioreactor; and (vi) bathing the engineered lung in a 4° C. solution comprising dextran and buffered at physiological pH. In another embodiment, preparing the engineered lung for transport is accomplished by (i) removing the engineered lung from a recellularization bioreactor; (ii) externally cooling the engineered lung in a 4° C. solution comprising dextran and buffered at physiological pH; (iii) flushing vasculature of the engineered lung with a 4° C. solution comprising dextran and buffered at physiological pH; (iv) performing bronchoscopy and suction on the engineered lung; (v) adding a surfactant into the engineered lung by the bronchoscope or other device to deliver the surfactant to an airway of the engineered lung; and (vi) ventilating the engineered lung with a FiO₂ of 0.21 to 1.0 followed by a manual inspiratory hold and airway clamp at peak inflation to trap gas in the engineered lung, wherein ventilating the engineered lung is performed with an electronic or manual (e.g., Ambu bag) mechanical ventilation device. Optionally, negative pressure support for ventilatory recruitment may be applied both before and during lung transport for transplant.

With respect to any embodiment of the previously described methods in which negative pressure is used, the engineered lung is preferably inflated with a negative pressure of at least about −1 cmH₂O, at least −5 cmH₂O, at least about −10 cmH₂O, at least about −15 cmH₂O, at least about −20 cmH₂O, at least about −25 cmH₂O, at least about −30 cmH₂O, at least about −35 cmH₂O, at least about −40 cmH₂O, or any range of values including and/or in between any two of these values. In some embodiments, the engineered lung is inflated with a negative pressure of at most −40 cmH₂O, at most −35 cmH₂O, at most −30 cmH₂O, at most −25 cmH₂O, at most −20 cmH₂O, at most −15 cmH₂O, at most −10 cmH₂O, at most −5 cmH₂O at most −1 cmH₂O, or any range or value including and/or in between any two of these values.

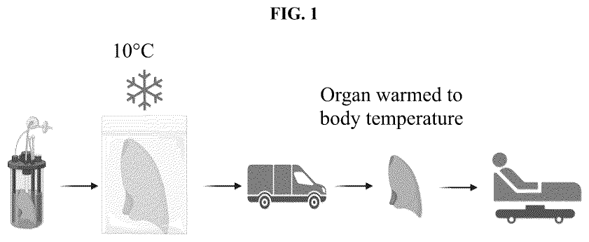

FIG. 1 illustrates an engineered organ, e.g., an engineered lung, in a recellularization bioreactor. In one embodiment, bronchoscopy, suction, and ventilation of the engineered lung is performed while the engineered lung remains in the recellularization bioreactor. In another embodiment, bronchoscopy, suction, and ventilation of the engineered lung is performed after the engineered lung is removed from the recellularization bioreactor. In both embodiments, after the engineered lung is removed from the recellularization bioreactor it is bathed and/or cooled in a 4° C. solution comprising dextran and buffered at physiological pH, and ventilated with a fraction of inspired oxygen (FiO₂) of 0.21-1.0 followed by a manual inspiratory hold and airway clamp to maintain the inspired oxygen in the engineered lung once the engineered lung is removed from the recellularization bioreactor.

In some embodiments, the engineered lung is bathed and/or cooled in a 4° C. solution comprising dextran and buffered at physiological pH for at least about 1 minute, at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, or at least about 60 minutes.

In some embodiments, the engineered lung is bathed and/or cooled in a 4° C. solution comprising dextran and buffered at physiological pH for at most about 60 minutes, at most about 55 minutes, at most about 50 minutes, at most about 45 minutes, at most about 40 minutes, at most about 35 minutes, at most about 30 minutes, at most about 25 minutes, at most about 20 minutes, at most about 15 minutes, at most about 10 minutes, at most about 5 minutes, or at most about 1 minute.

In some embodiments, the engineered lung is bathed and/or cooled in a 4° C. solution comprising dextran and buffered at physiological pH for between about 1 minute and about 5 minutes, between about 5 minutes and about 10 minutes, between about 10 minutes and about 15 minutes, between about 15 minutes and about 20 minutes, between about 20 minutes and about 25 minutes, between about 25 minutes and about 30 minutes, between about 30 minutes and about 35 minutes, between about 35 minutes and about 40 minutes, between about 40 minutes and about 45 minutes, between about 45 minutes and about 50 minutes, between about 50 minutes and about 55 minutes, between about 55 minutes and about 60 minutes, or any range or value including and/or in between any two of these values.

In some embodiments, the engineered lung is ventilated at least about 1 time, at least about 10 times, at least about 20 times, at least about 30 times, at least about 40 times, at least about 50 times, at least about 60 times, at least about 70 times, at least about 80 times, at least about 90 times, at least about 100 times, at least about 110 times, at least about 120 times, at least about 130 times, at least about 140 times, at least about 150 times, at least about 160 times, at least about 170 times, at least about 180 times, at least about 190 times, or at least about 200 times.

In some embodiments, the engineered lung is ventilated at most about 200 times, at most about 190 times, at most about 180 times, at most about 170 times, at most about 160 times, at most about 150 times, at most about 140 times, at most about 130 times, at most about 120 times, at most about 110 times, at most about 100 times, at most about 90 times, at most about 80 times, at most about 70 times, at most about 60 times, at most about 50 times, at most about 40 times, at most about 30 times, at most about 20 times, at most about 10 times, or at most about 1 time.

In some embodiments, the engineered lung is ventilated between about 200 times and about 190 times, between about 190 times and about 180 times, between about 180 times and about 170 times, between about 170 times and about 160 times, between about 160 times and about 150 times, between about 150 times and about 140 times, between about 140 times and about 130 times, between about 130 times and about 120 times, between about 120 times and about 110 times, between about 110 times and about 100 times, between about 100 times and about 90 times, between about 90 times and about 80 times, between about 80 times and about 70 times, between about 70 times and about 60 times, between about 60 times and about 50 times, between about 50 times and about 40 times, between about 40 times and about 30 times, between about 30 times and about 20 times, between about 20 times and about 10 times, between about 10 times and about 1 time, or any range or value including and/or in between any two of these values.

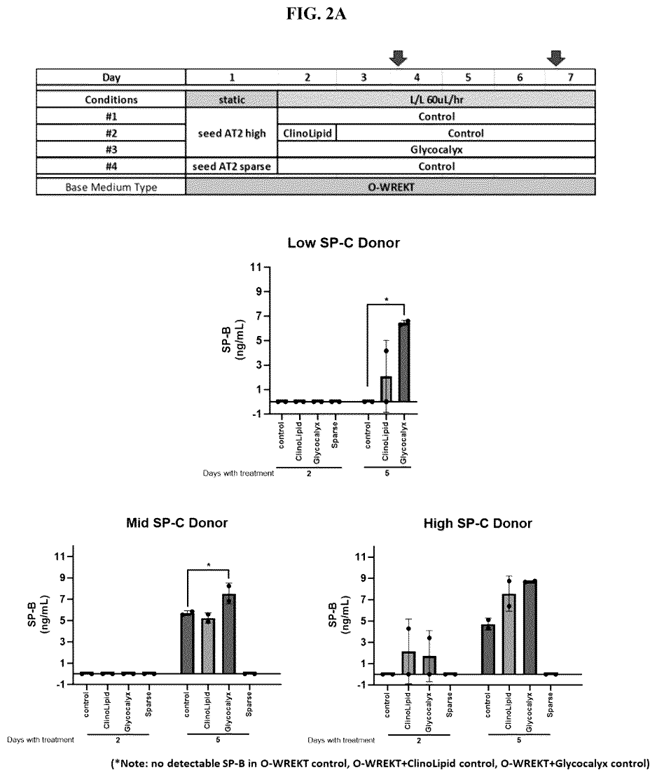

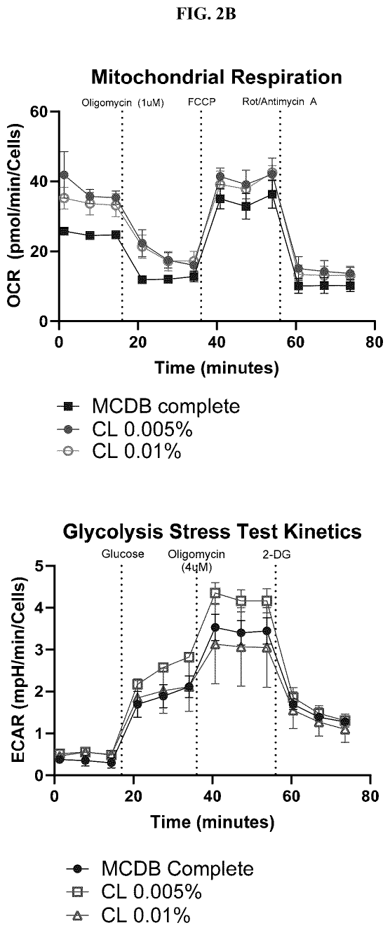

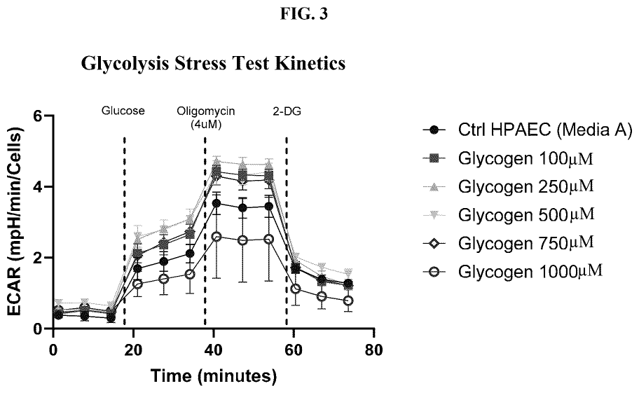

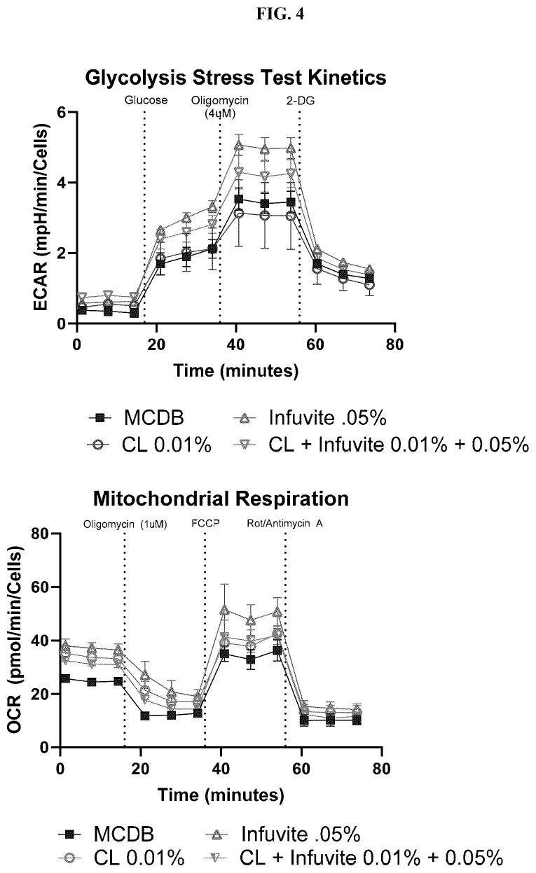

In one aspect, the 4° C. solution comprising dextran and buffered at physiological pH bathing and/or cooling the engineered organ optionally comprises an additive to increase mitochondrial respiration and/or reduce apoptosis, the additive selected from the group of: an omega-9 monounsaturated fatty acid and omega-6 polyunsaturated fatty acid admixture (e.g., Clinolipid); CaCl₂; glycogen; L-alanyl-L-glutamine (e.g., GlutaMax); an vitamin B1, vitamin B2, vitamin B6, vitamin B12, niacinamide, dexpanthenol, folic acid, and biotin admixture (e.g., Infuvite); isolated mitochondria; albumin; trehalose; niacinamide; pyruvate; or combinations thereof. As shown in FIG. 2A, Clinolipid increases surfactant protein B (SP-B) secretion in a lung model, and as shown in FIG. 2B, Clinolipid also increases nutrient metabolism in Human Pulmonary Artery Endothelial Cells (HPAEC). Glycogen (FIG. 3) and Infuvite (FIG. 4) also increase nutrient metabolism in HPAEC, and L-alanyl-L-glutamine has been demonstrated to improve human lung cell function. See, e.g., Huang, Lei, et al. “L-alanyl-L-glutamine modified perfusate improves human lung cell functions and extend porcine ex vivo lung perfusion.” The Journal of Heart and Lung Transplantation 42.2 (2023): 183-195.

In some embodiments, the solution comprises the additive at concentration of at least about 0.0000001 wt. %, at least about 0.0000005 wt. %, at least about 0.000001 wt. %, at least about 0.000005 wt. %, at least about 0.00001 wt%, at least about 0.00005 wt. %, at least about 0.0001 wt. %, at least about 0.0005 wt. %, at least about 0.001 wt. %, at least about 0.005 wt. at least about 0.01 wt. %, at least about 0.05 wt. %, at least about 0.1 wt%, at least about 0.5 wt. %, or at least about 1.0 wt. %.

In some embodiments, the solution comprises the additive at concentration of at most about 1.0 wt. %, at most about 0.5 wt. %, at most about 0.1 wt. %, at most about 0.05 wt. %, at most about 0.01 wt. %, at most about 0.005 wt. %, at most about 0.001 wt. %, at most about 0.0005 wt. %, at most about 0.0001 wt. %, at most about 0.00005 wt. %, at most about 0.00001 wt. %, at most about 0.000005 wt. %, at most about 0.000001 wt. %, at most about 0.0000005 wt. %, or at most about 0.0000001 wt. %.

In some embodiments, the solution comprises the additive at concentration of between about 1.0 wt. %, and about 0.5 wt. %, between about 0.5 wt. %, and about 0.1 wt. %, between about 0.1 wt. %, and about 0.05 wt. %, between about 0.05 wt. %, and about 0.01 wt. %, between about 0.01 wt. %, and about 0.005 wt. %, between about 0.005 wt. %, and about 0.001 wt. %, between about 0.001 wt. %, and about 0.0005 wt. %, between about 0.0005 wt. %, and about 0.0001 wt. %, between about 0.0001 wt. %, and about 0.00005 wt. %, between about 0.00005 wt. %, and about 0.00001 wt. %, between about 0.00001 wt. %, and about 0.000005 wt. %, between about 0.000005 wt. %, and about 0.000001 wt. %, between about 0.000001 wt. %, and about 0.0000005 wt. %, between about 0.0000005 wt. %, and about 0.0000001 wt. %, or any range or value including and/or in between any two of these values.

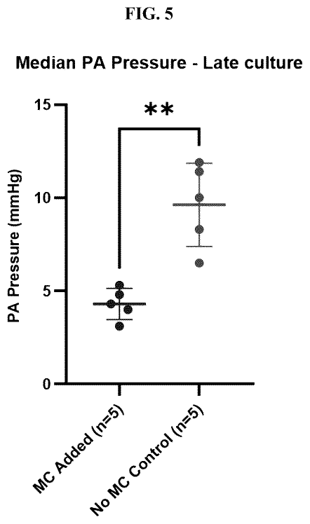

In another aspect, the 4° C. solution comprising dextran and buffered at physiological pH bathing and/or cooling the engineered organ optionally comprises methylcellulose or other space-filling or bulk-adding substance to support the engineered lung's extracellular matrix (ECM) and/or attenuate fluid leak through the ECM. As shown in FIG. 5, methylcellulose lowers pulmonary vascular resistance in late bioengineered lung cultures.

In some embodiments, the solution comprises the methylcellulose or other space-filling or bulk-adding substance at concentration of at least about 0.0000001 wt. %, at least about 0.0000005 wt. %, at least about 0.000001 wt. %, at least about 0.000005 wt. %, at least about 0.00001 wt%, at least about 0.00005 wt. %, at least about 0.0001 wt. %, at least about 0.0005 wt. %, at least about 0.001 wt. %, at least about 0.005 wt. at least about 0.01 wt. %, at least about 0.05 wt. %, at least about 0.1 wt%, at least about 0.5 wt. %, or at least about 1.0 wt. %.

In some embodiments, the solution comprises the methylcellulose or other space-filling or bulk-adding substance at concentration of at most about 1.0 wt. %, at most about 0.5 wt. %, at most about 0.1 wt. %, at most about 0.05 wt. %, at most about 0.01 wt. %, at most about 0.005 wt. %, at most about 0.001 wt. %, at most about 0.0005 wt. %, at most about 0.0001 wt. %, at most about 0.00005 wt. %, at most about 0.00001 wt. %, at most about 0.000005 wt. %, at most about 0.000001 wt. %, at most about 0.0000005 wt. %, or at most about 0.0000001 wt. %.

In some embodiments, the solution comprises the methylcellulose or other space-filling or bulk-adding substance at concentration of between about 1.0 wt. %, and about 0.5 wt. %, between about 0.5 wt. %, and about 0.1 wt. %, between about 0.1 wt. %, and about 0.05 wt. %, between about 0.05 wt. %, and about 0.01 wt. %, between about 0.01 wt. %, and about 0.005 wt. %, between about 0.005 wt. %, and about 0.001 wt. %, between about 0.001 wt. %, and about 0.0005 wt. %, between about 0.0005 wt. %, and about 0.0001 wt. %, between about 0.0001 wt. %, and about 0.00005 wt. %, between about 0.00005 wt. %, and about 0.00001 wt. %, between about 0.00001 wt. %, and about 0.000005 wt. %, between about 0.000005 wt. %, and about 0.000001 wt. %, between about 0.000001 wt. %, and about 0.0000005 wt. %, between about 0.0000005 wt. %, and about 0.0000001 wt. %, or any range or value including and/or in between any two of these values.

In yet another aspect, the present disclosure provides a method of transporting a native or engineered organ for transplant. FIG. 1 illustrates an engineered organ, e.g., an engineered lung, being removed from a recellularization bioreactor and transported to a transplantation site at 10° C. In one embodiment, preparing the native or engineered organ for transport is accomplished by providing a first container (e.g., isolation bag) containing a 10° C. solution comprising dextran and buffered at physiological pH and configured to receive and hold the native or engineered organ therein; providing a second container configured to receive and hold the first container therein; placing the native or engineered organ into the first container; placing the first container into the second container; and transporting the native or engineered organ, wherein the second container preserves the temperature of the native or engineered organ at a temperature of about 10° C. for at least 2 hours. In some embodiments, the first container is a double organ isolation bag.

In some embodiments, the second container preserves the temperature of the native or engineered organ at a temperature of about 10° C. for at least about 2 hours, for at least about 5 hours, at least about 10 hours, at least about 15 hours, at least about 20 hours, at least about 25 hours, at least about 30 hours, at least about 35 hours, at least about 40 hours, at least about 45 hours, at least about 50 hours, at least about 55 hours, at least about 60 hours, at least about 65 hours, at least about 70 hours, at least about 75 hours, at least about 80 hours, at least about 85 hours, at least about 90 hours, at least about 95 hours, or at least about 100 hours.

In some embodiments, the second container preserves the temperature of the native or engineered organ at a temperature of about 10° C. for at most about 100 hours, at most about 95 hours, at most about 90 hours, at most about 85 hours, at most about 80 hours, at most about 75 hours, at most about 70 hours, at most about 65 hours, at most about 60 hours, at most about 55 hours, at most about 50 hours, at most about 45 hours, at most about 40 hours, at most about 35 hours, at most about 30 hours, at most about 25 hours, at most about 20 hours, at most about 15 hours, at most about 10 hours, at most about 5 hours, or at most about 2 hours.

In some embodiments, the second container preserves the temperature of the native or engineered organ at a temperature of about 10° C. for between about 2 hours and about 5 hours, for between about 5 hours and about 10 hours, between about 10 hours and about 15 hours, between about 15 hours and about 20 hours, between about 20 hours and about 25 hours, between about 25 hours and about 30 hours, between about 30 hours and about 35 hours, between about 35 hours and about 40 hours, between about 40 hours and about 45 hours, between about 45 hours and about 50 hours, between about 50 hours and about 55 hours, between about 55 hours and about 60 hours, between about 60 hours and about 65 hours, between about 65 hours and about 70 hours, between about 70 hours and about 75 hours, between about 75 hours and about 80 hours, between about 80 hours and about 85 hours, between about 85 hours and about 90 hours, between about 90 hours and about 95 hours, between about 95 hours and about 100 hours, or any range or value including and/or in between any two of these values.

In one aspect, the 10° C. solution comprising dextran and buffered at physiological pH bathing and/or cooling the native or engineered organ optionally comprises an additive to increase mitochondrial respiration and/or reduce apoptosis, the additive selected from the group of: an omega-9 monounsaturated fatty acid and omega-6 polyunsaturated fatty acid admixture (e.g., Clinolipid); CaCl₂; glycogen; L-alanyl-L-glutamine (e.g., GlutaMax); an vitamin B1, vitamin B2, vitamin B6, vitamin B12, niacinamide, dexpanthenol, folic acid, and biotin admixture (e.g., Infuvite); isolated mitochondria; albumin; trehalose; niacinamide; pyruvate; or combinations thereof. As shown in FIG. 2A, Clinolipid increases surfactant protein B (SP-B) secretion in a lung model, and as shown in FIG. 2B, Clinolipid also increases nutrient metabolism in Human Pulmonary Artery Endothelial Cells (HPAEC). Glycogen (FIG. 3) and Infuvite (FIG. 4) also increase nutrient metabolism in HPAEC, and L-alanyl-L-glutamine has been demonstrated to improve human lung cell function. See, e.g., Huang, Lei, et al. “L-alanyl-L-glutamine modified perfusate improves human lung cell functions and extend porcine ex vivo lung perfusion.” The Journal of Heart and Lung Transplantation 42.2(2023 ): 183-195.

In another aspect, the 10° C. solution comprising dextran and buffered at physiological pH bathing and/or cooling the native or engineered organ optionally comprises methylcellulose or other space-filling or bulk-adding substance to support the native or engineered organ's extracellular matrix (ECM) and/or attenuate fluid leak through the ECM. As shown in FIG. 5, methylcellulose lowers pulmonary vascular resistance in late bioengineered lung cultures.

In some embodiments, the native or engineered organ is contacted with an additive to increase mitochondrial respiration and/or reduce apoptosis prior to placing the native or engineered organ in the first container, wherein the additive is selected from: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof. In some embodiments, the native or engineered organ is contacted methylcellulose or other space-filling or bulk-adding substance to support the native or engineered organ's ECM and/or attenuate fluid leak through the ECM prior to placing the native or engineered organ in the first container. As used herein, contacting before placing the engineered organ in the first container includes, but is not limited to, contacting the engineered organ while it is undergoing a recellularization process in a bioreactor, or contacting the engineered organ after the recellularization process is complete, e.g., with a flush solution while the engineered organ remains in the recellularization bioreactor.

In other embodiments, as illustrated in FIG. 1, the first container (e.g., isolation bag) is removed from the second container and the native or engineered organ is rewarmed to body temperature. In some embodiments, rewarming the native or engineered organ to body temperature includes removing the native or engineered organ from the first container and placing the native or engineered organ in a transplant recipient's body cavity. In some embodiments, rewarming the native or engineered organ includes contacting the native or engineered organ with an additive to increase mitochondrial respiration and/or reduce apoptosis prior to placing the native or engineered organ in the first container, wherein the additive is selected from: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof. In some embodiments, rewarming the native or engineered organ includes contacting the native or engineered organ with methylcellulose or other space-filling or bulk-adding substance to support the engineered organ's ECM and/or attenuate fluid leak through the ECM.

In some embodiments, the native or engineered organ is contacted with the additive and/or methylcellulose or other space-filling or bulk-adding substance in a solution at concentration of at least about 0.0000001 wt. %, at least about 0.0000005 wt. %, at least about 0.000001 wt. %, at least about 0.000005 wt. %, at least about 0.00001 wt%, at least about 0.00005 wt. %, at least about 0.0001 wt. %, at least about 0.0005 wt. %, at least about 0.001 wt. %, at least about 0.005 wt. at least about 0.01 wt. %, at least about 0.05 wt. %, at least about 0.1 wt %, at least about 0.5 wt. %, or at least about 1.0 wt. %.

In some embodiments, the native or engineered organ is contacted with the additive and/or methylcellulose or other space-filling or bulk-adding substance in a solution at concentration of at most about 1.0 wt. %, at most about 0.5 wt. %, at most about 0.1 wt. %, at most about 0.05 wt. %, at most about 0.01 wt. %, at most about 0.005 wt. %, at most about 0.001 wt. %, at most about 0.0005 wt. %, at most about 0.0001 wt. %, at most about 0.00005 wt. %, at most about 0.00001 wt. %, at most about 0.000005 wt. %, at most about 0.000001 wt. %, at most about 0.0000005 wt. %, or at most about 0.0000001 wt. %.

In some embodiments, the native or engineered organ is contacted with the additive and/or methylcellulose or other space-filling or bulk-adding substance at concentration of between about 1.0 wt. %, and about 0.5 wt. %, between about 0.5 wt. %, and about 0.1 wt. %, between about 0.1 wt. %, and about 0.05 wt. %, between about 0.05 wt. %, and about 0.01 wt. %, between about 0.01 wt. %, and about 0.005 wt. %, between about 0.005 wt. %, and about 0.001 wt. %, between about 0.001 wt. %, and about 0.0005 wt. %, between about 0.0005 wt. %, and about 0.0001 wt. %, between about 0.0001 wt. %, and about 0.00005 wt. %, between about 0.00005 wt. %, and about 0.00001 wt. %, between about 0.00001 wt. %, and about 0.000005 wt. %, between about 0.000005 wt. %, and about 0.000001 wt. %, between about 0.000001 wt. %, and about 0.0000005 wt. %, between about 0.0000005 wt. %, and about 0.0000001 wt. %, or any range or value including and/or in between any two of these values.

In yet another aspect, the present disclosure provides for beneficial organ transplant solutions comprising a buffer to maintain physiological pH and dextran. In some embodiments, the solution includes an additive selected from: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof. In some embodiments, the solution includes methylcellulose or other space-filling or bulk-adding substance.

In some embodiments, the solution comprises the additive and/or methylcellulose or other space-filling or bulk-adding substance at concentration of at least about 0.0000001 wt. %, at least about 0.0000005 wt. %, at least about 0.000001 wt. %, at least about 0.000005 wt. %, at least about 0.00001 wt %, at least about 0.00005 wt. %, at least about 0.0001 wt. %, at least about 0.0005 wt. %, at least about 0.001 wt. %, at least about 0.005 wt. at least about 0.01 wt. %, at least about 0.05 wt. %, at least about 0.1 wt%, at least about 0.5 wt. %, or at least about 1.0 wt. %.

In some embodiments, the solution comprises the additive and/or methylcellulose or other space-filling or bulk-adding substance at concentration of at most about 1.0 wt. %, at most about 0.5 wt. %, at most about 0.1 wt. %, at most about 0.05 wt. %, at most about 0.01 wt. %, at most about 0.005 wt. %, at most about 0.001 wt. %, at most about 0.0005 wt. %, at most about 0.0001 wt. %, at most about 0.00005 wt. %, at most about 0.00001 wt. %, at most about 0.000005 wt. %, at most about 0.000001 wt. %, at most about 0.0000005 wt. %, or at most about 0.0000001 wt. %.

In some embodiments, the solution comprises the additive and/or methylcellulose or other space-filling or bulk-adding substance at concentration of between about 1.0 wt. %, and about 0.5 wt. %, between about 0.5 wt. %, and about 0.1 wt. %, between about 0.1 wt. %, and about 0.05 wt. %, between about 0.05 wt. %, and about 0.01 wt. %, between about 0.01 wt. %, and about 0.005 wt. %, between about 0.005 wt. %, and about 0.001 wt. %, between about 0.001 wt. %, and about 0.0005 wt. %, between about 0.0005 wt. %, and about 0.0001 wt. %, between about 0.0001 wt. %, and about 0.00005 wt. %, between about 0.00005 wt. %, and about 0.00001 wt. %, between about 0.00001 wt. %, and about 0.000005 wt. %, between about 0.000005 wt. %, and about 0.000001 wt. %, between about 0.000001 wt. %, and about 0.0000005 wt. %, between about 0.0000005 wt. %, and about 0.0000001 wt. %, or any range or value including and/or in between any two of these values.

As used herein, the term “organ” refers to a part or structure of the body, which is adapted for a special function or functions. For example, an organ may be a lung, a liver, a kidney, a heart, a pancreas, a bowel, including a stomach and intestines. The organ can be human, animal, 3D printed, or bioengineered. In some embodiments, the native or engineered organ is selected from the group consisting of: lung, heart, liver, or kidney.

After being preserved and/or transported, the native or engineered organ may be transplanted into a subject, such as a warm-blooded animal, e.g., a mammal, such as a human being.

The methods of the present disclosure may significantly reduce costs associated with preserving, storing and/or transporting native or engineered organs. In addition, the methods of the present disclosure are able to maintain the native or engineered organ in a state that is suitable for its intended use, e.g., it maintains a native or engineered organ in a condition suitable for performing a transplant into a recipient after the period of time in which the method is practiced.

In some embodiments, the second container may be the container disclosed in U.S. application Ser. No. 18/925364, which is herein incorporated by reference in its entirety.

In some embodiments, the dextrins of the present disclosure have a molecular weight of between about 3 kDa and about 2 MDa. In some embodiments, the dextrin has a molecular weight of at least about 5 kDa, at least about 10 kDa, at least about 20 kDa, at least about 40 kDa, at least about 80 kDa, at least about 160 kDa, or at least about 320 kDa. In some embodiments, the dextrin has a molecular weight of at most about 320 kDa, at most about 160 kDa, at most about 80 kDa, at most about 40 kDa, at most about 20 kDa, at most about 10 kDa, or at most about 5 kDa. In a preferred embodiment, the dextrin has a molecular weight of 40 kDa, e.g., dextrin 40.

Embodiments described herein are further illustrated by, though in no way limited to, the following working examples.

### EXAMPLES

FIG. 2A: An omega-9 monounsaturated fatty acid and omega-6polyunsaturated fatty acid admixture (e.g., Clinolipid) increases surfactant protein B (SP-B) secretion in a lung model. Donor alveolar type 2 cells (AT2) expressing low, mid, and high amounts of surfactant protein C (SP-C) were seeded in an Emulate lung-chip model. Models treated with Clinolipid displayed significantly more surfactant protein B (SP-B) secretion than control models at 5 days post treatment. SP-B is an essential lipid-associated protein found in pulmonary surfactant that enables lung inflation.

FIG. 2B: An omega-9 monounsaturated fatty acid and omega-6 polyunsaturated fatty acid admixture (e.g., Clinolipid) increases nutrient metabolism in Human Pulmonary Artery Endothelial Cells (HPAEC). The oxygen consumption rate (OCR) and extracellular acidification rate (ECAR) of HPEAC was increased by the inclusion of 0.01% or 0.005% Clinolipid (CL) in MCDB complete media, indicating that an omega-9 monounsaturated fatty acid and omega-6 polyunsaturated fatty acid admixture increases HPEAC nutrient metabolism.

FIG. 3: Glycogen increases nutrient metabolism in HPAEC. The ECAR of HPEAC was increased by the inclusion of 100, 250, 500, and 750 μM glycogen in Medial A, indicating the glycogen increases HPEAC nutrient metabolism.

FIG. 4: A vitamin B1, vitamin B2, vitamin B6, vitamin B12, niacinamide, dexpanthenol, folic acid, and biotin admixture (e.g., Infuvite) increases nutrient metabolism in HPAEC. The oxygen consumption rate (OCR) and extracellular acidification rate (ECAR) of HPEAC was increased by the inclusion of 0.05% Infuvite (CL) in MCDB complete media, indicating that a vitamin B1, vitamin B2, vitamin B6, vitamin B12, niacinamide, dexpanthenol, folic acid, and biotin admixture admixture increases HPEAC nutrient metabolism.

FIG. 5: Methylcellulose lowers pulmonary vascular resistance in late bioengineered lung cultures. Late culture bioengineered lungs treated with methylcellulose (MC) showed significantly lower pulmonary artery (PA) pressure compared to untreated bioengineered lungs. Without wishing to be bound to any particular theory, Applicant believes methylcellulose may support the extracellular matrix of cells of the engineered lung, thereby preventing edema and microvascular collapse.

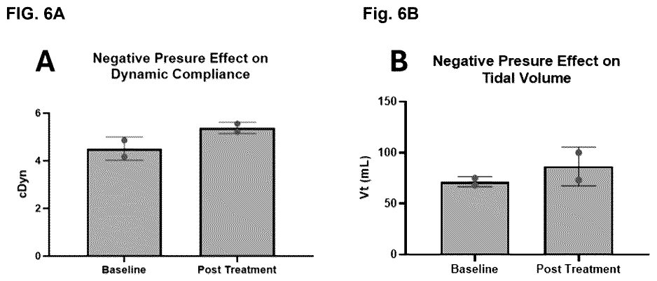

FIG. 6: Negative pressure provides increase in measured tidal volume post treatment. FIG. 6A shows increase in measured tidal volume post treatment with negative pressure for recruitment of a representative native lung model, and FIG. 6B shows increase in measured dynamic compliance post treatment with negative pressure recruitment in a representative native lung model. Ventilation support remained constant for all measurements. In this study, native porcine lungs were acquired and put on an EVLP station. The lungs were perfused with Low Potassium Dextran Solution containing Albumin is a perfusate with an osmolarity similar to blood but without the red blood cells. The lungs were perfused and ventilated for an hour in preparation for assessment (this is a standard method of recruitment). The baseline metrics were recorded. Negative pressure was manually applied to the native lungs using a hand pump, and metrics were recorded while the lung was subjected to this treatment, using a pressure of −5 cmH2O to −11 cmH2O during the negative pressure treatment. The negative pressure was then removed and final metrics were recorded. Metrics at baseline and post-treatment are shown in FIG. 6. Over the range of negative pressure values tested in this study, lungs with higher dynamic compliance and tidal volume resulted.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed is:

1. A method for preparing an engineered lung for transport, comprising:
(i) performing bronchoscopy and suction on the engineered lung, wherein the engineered lung remains in a recellularization bioreactor;
(ii) adding a surfactant by the bronchoscope or other device to deliver the surfactant to an airway of the engineered lung;
(iii) ventilating the engineered lung with a fraction of inspired oxygen (FiO₂) of 0.21 to 1.0 followed by a manual inspiratory hold and airway clamp to maintain the inspired oxygen in the engineered lung, wherein ventilating the engineered lung is performed with an electronic or manual mechanical ventilation device;
(iv) clamping the airway when the engineered lung is inflated;
(v) removing the engineered lung from the recellularization bioreactor; and
(vi) bathing the engineered lung in a 4° C. solution comprising dextran and buffered at physiological pH.

2. A method for preparing an engineered lung for transport, comprising:
(i) removing the engineered lung from a recellularization bioreactor;
(ii) externally cooling the engineered lung in a 4° C. solution comprising dextran and buffered at physiological pH;
(iii) flushing vasculature of the engineered lung with a 4° C. solution comprising dextran and buffered at physiological pH;
(iv) performing bronchoscopy and suction on the engineered lung;
(v) adding a surfactant into the engineered lung by the bronchoscope or other device to deliver the surfactant to an airway of the engineered lung; and
(vi) ventilating the engineered lung with a FiO₂ of 0.21 to 1.0 followed by a manual inspiratory hold and airway clamp at peak inflation to trap gas in the engineered lung, wherein ventilating the engineered lung is performed with an electronic or manual mechanical ventilation device.

3. The method of claim 1, wherein the solution further comprises an additive to increase mitochondrial respiration and/or reduce apoptosis, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof.

4. The method of claim 1, wherein the solution further comprises methylcellulose or other space-filling or bulk-adding substance to support the engineered organ's extracellular matrix (ECM) and/or attenuate fluid leak through the ECM.

5. The method of claim 1, wherein negative pressure of about −1 to about −40 cmH2O is applied externally to the engineered lung during ventilatory recruitment, dynamic ventilation, or post-ventilation for inflation prior to clamping of an airway at peak lung inflation for transport in an inflated state, and the negative pressure is applied with an electronic or manual device.

6. A method of transporting a native or engineered organ for transplant, comprising providing a first container containing a 10° C. solution comprising dextran and buffered at physiological pH and configured to receive and hold the native or engineered organ therein; providing a second container configured to receive and hold the first container therein; placing the native or engineered organ into the first container; placing the first container into the second container; and transporting the native or engineered organ, wherein the second container preserves the temperature of the native or engineered organ at a temperature of about 10° C. for at least 2 hours.

7. The method of claim 6, wherein the second container preserves the temperature of the native or engineered organ at a temperature of about 10° C. for at least 5 hours.

8. The method of claim 6, wherein the second container preserves the temperature of the native or engineered organ at a temperature of about 10° C. for at least 10 hours.

9. The method of claim 6, wherein the second container preserves the temperature of the native or engineered organ at a temperature of about 10° C. for at least 15 hours.

10. The method of claim 6, wherein the first container is an organ isolation bag.

11. The method of claim 6, wherein the 10° C. solution comprising dextran and buffered at physiological pH further comprises an additive to increase mitochondrial respiration and/or reduce apoptosis, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof.

12. The method of claim 6, wherein the 10° C. solution comprising dextran and buffered at physiological pH solution further comprises methylcellulose or other space-filling or bulk-adding substance to support the native or engineered organ's ECM and/or attenuate fluid leak through the ECM.

13. The method of claim 6, further comprising contacting the native or engineered organ with an additive to increase mitochondrial respiration and/or reduce apoptosis prior to placing the native or engineered lung in the first container, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof.

14. The method of claim 6, further comprising contacting the native or engineered organ with methylcellulose or other space-filling or bulk-adding substance to support the native or engineered organ's ECM and/or attenuate fluid leak through the ECM prior to placing the native or engineered organ in the first container.

15. The method of claim 6, further comprising removing the first container from the second container and rewarming the native or engineered organ to body temperature, wherein rewarming the native or engineered organ comprises contacting the native or engineered organ with an additive to increase mitochondrial respiration and/or reduce apoptosis, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof.

16. The method of claim 15, further comprising delivering a bolus of the additive to the native or engineered organ.

17. The method of claim 6, further comprising removing the isolation bag from the second container and rewarming the native or engineered organ to body temperature, wherein rewarming the native or engineered organ comprises contacting the engineered organ with methylcellulose or other space-filling or bulk-adding substance to support the native or engineered organ's ECM and/or attenuate fluid leak through the ECM.

18. The method of claim 15, wherein rewarming the native or engineered organ to body temperature further comprises removing the native or engineered organ from the first container and placing the native or engineered organ in a transplant recipient's body cavity.

19. The method of claim 6, wherein the native or engineered organ is selected from the group consisting of: lung, heart, liver, or kidney.

20. A solution comprising a buffer to maintain physiological pH, dextran, and an additive, wherein the additive is selected from the group consisting of: an omega-9 monounsaturated fatty acid and omega-6 polyunsaturated fatty acid admixture; CaCl₂; glycogen; L-alanyl-L-glutamine; an vitamin B1, vitamin B2, vitamin B6, vitamin B12, niacinamide, dexpanthenol, folic acid, and biotin admixture; isolated mitochondria; albumin; trehalose; niacinamide; pyruvate; or combinations thereof.

21. A solution comprising a buffer to maintain physiological pH, dextran, and methylcellulose or other space-filling or bulk-adding substance.
